(19) United States
(12) Patent Application Publication
(10) Pub. No.: US 2018/0222059 A1
(43) Pub. Date: Aug. 9, 2018

(54) LAW ENFORCEMENT ROBOT

(71) Applicants: Kanishka Ragula, Salt Lake City, UT (US); Vikrant Ragula, Salt Lake City, UT (US)

(72) Inventors: Kanishka Ragula, Salt Lake City, UT (US); Vikrant Ragula, Salt Lake City, UT (US)

(21) Appl. No.: 15/424,825

(22) Filed: Feb. 4, 2017

(51) Int. Cl. B25J 11/00; H04N 7/14; B25J 19/02; B25J 13/00; G05D 1/00

(52) U.S. Cl. CPC B25J 11/0005; H04N 7/142; H04N 7/147; B25J 19/023; B25J 19/026; G05D 2201/0209; G05D 1/0022; G05D 1/0016; Y10S 901/01; Y10S 901/47; B25J 13/006

(57) ABSTRACT

Interactive police robotic apparatus, interactive law enforcement systems, as well as law enforcement applications and methods. Certain embodiments include a system of a police robotic apparatus in combination with a law enforcement officer terminal. A law enforcement robot is deployed for in initial interaction with a civilian. This initial interaction can be to identify the civilian during a traffic stop, for example. The initial interaction can include the deployment of the robot so as to initially record and interact with the civilian without direct physical interaction or proximity between the law enforcement officer and the civilian. The robot can accomplish initial audio and video communication between the officer and the civilian and display the officer's face and voice to the citizen so as to put the citizen at ease during the initial interaction with the law enforcement officer.

### BACKGROUND

Thousands of traffic stops take place daily across America's highways and byways. These interactions are carried out by officers whose vehicles have traditional safety features such as wireless access to criminal databases, communication with other officers and personnel, vehicle borne cameras, as well partitions for detaining subjects of arrest. These officers also generally carry firearms and other weapons, as well as handcuffs for detaining a suspect. The officers generally wear protective equipment such as a bullet-proof vest in anticipation of a dangerous altercation. Yet, the traffic stop remains one of the most dangerous aspects of police work. And this initial law enforcement interaction with citizens, such as the traffic stop, is often carried out in an unpredictable location. Whether predictable or not, the location of the initial interaction between an officer and a citizen can involve dangerous and sometimes unanticipated circumstances. These circumstances can challenge the ability of even well-trained police officers to safely access and react to every situation.

The initial police interaction can also be extremely stressful even to law-abiding citizens. In fact, even a simple stop for a traffic violation by a police officer can create apprehension for otherwise law abiding citizens. Thus, the direct initial interaction with a police officer may create unnecessary police officer and citizen tension associated with administration of even a minor infraction and fine.

On the other hand, the officer cannot be entirely certain that the citizen is such a law-abiding citizen until the officer is able to verify the citizen's identity. The officer may also be placed in an awkward position due to the unease of the citizen. And, it may well be that the citizen is a dangerous criminal and it is this inherent uncertainty of the initial interaction that lends itself to the dangerous unpredictability. Thus, this unpredictability of the initial interaction between a police officer and an individual citizen can lead to unnecessarily stressful interactions, resentment, or unnecessary bodily danger but-for the solutions to which this invention is directed.

Recent events reinforce the dangers faced by police officers as well as citizens every day in these initial law enforcement interactions. The initial interaction between a police officer and one or more citizens is often unpredictable in that it may, or may not, involve life-threatening dangers. In addition to the dangers that are observable only upon the initial interaction there are emotions, tensions, and impulse reactions that are part of human nature. Officers cannot be equipped to safely respond to these unpredictable events, nor can even calm and rational officers be trained to predictably anticipate and respond to some inherently emotional and unpredictable encounters with citizens. Thus, there exists a need for an inter-personal interaction device to initially place the law enforcement officer in communication with the citizen so as to preliminarily identify the citizen and access the situation without the immediate close direct physical proximity of the officer to the citizen.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

The various teachings and embodiments discussed in this description by the inventors are illustrative of interactive police robotic apparatus as well as novel law enforcement applications and methods. Certain embodiments include a system of a police robotic apparatus in combination with a law enforcement officer terminal. The law enforcement officer terminal may be accessed from within the police car as the law enforcement robotic apparatus is deployed therefrom. The robot can be transported by the police car and can be made portable thereby.

A mobile law enforcement communications system for providing initial on-site interaction between a law enforcement officer and a citizen is disclosed. The system can include a mobile law enforcement robot. The robot includes a robotic transportation apparatus for transporting the robot proximate to the citizen, a robotic wireless communications module for transmitting and receiving data with a law enforcement officer terminal, and a robotic audio and visual communication device configured to display real-time video data and communicate real-time audio information from the officer to the citizen during the initial interaction.

The law enforcement officer terminal is in wireless communication with the mobile law enforcement robot. The officer terminal includes an wireless communications module for transmitting and receiving data with the mobile law enforcement robot and an audio and visual communication device configured to display real-time video data and communicate real-time audio information from the citizen to the officer during the initial interaction.

A mobile law enforcement robotic apparatus can providing an on-site interaction interface between a law enforcement officer and a citizen during an initial on-site law enforcement interaction. The robotic apparatus can include a support structure and transport means coupled to the support structure and configured to transport the robotic apparatus to different positions. The robotic apparatus can include a visual display supported by the support structure, the visual display sized to display law enforcement officer imagery including the face of the law enforcement officer during the initial on-site law enforcement interaction. The robotic apparatus can include a camera supported by the support structure, the camera capturing real-time imagery of the citizen during the initial on-site law enforcement interaction. The robotic apparatus can include a microphone supported by the support structure, the microphone for receiving audio communication from the citizen during the initial on-site law enforcement interaction. The robotic apparatus can include a speaker supported by the support structure, the speaker for transmitting officer audio communication to the citizen during the initial on-site law enforcement interaction. The robotic apparatus can include a wireless transceiver supported by the support structure, the wireless transceiver for transmitting and receiving wireless data to and from the mobile robotic apparatus during the initial on-site law enforcement interaction.

The robotic apparatus can include an electronic communications control module supported by the support structure. The electronic communications control module can include a video communications module configured to receive the officer imagery from the wireless transceiver during the initial on-site law enforcement interaction and display the officer imagery on the visual display depicting the officer during the initial on-site law enforcement interaction. The electronic communications control module can be configured to receive the citizen imagery from the camera depicting the citizen during the initial on-site law enforcement interaction and transmit the citizen imagery to the wireless transceiver module during the initial on-site law enforcement interaction.

The robotic apparatus control module can include an audio communications module configured to receive officer audio communication data from the wireless transceiver during the initial on-site law enforcement interaction, transmit the officer audio communication data to the speaker during the initial on-site law enforcement interaction, receive citizen audio communication from the microphone during the initial on-site law enforcement interaction, and transmit citizen audio communication to the wireless transceiver during the initial on-site law enforcement interaction.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1, illustrates an initial law enforcement stop between a law enforcement officer in a law enforcement vehicle and a citizen 110 in the citizen's vehicle;

FIG. 2 illustrates communication and control modules of the law enforcement systems and apparatus;

FIG. 3 illustrates an example of the component of a computing system that includes various examples of individual devices that can be included in the officer terminal and/or mobile law enforcement robotic apparatus; and

FIGS. 4A and 4B illustrate a collapsible robotic configuration.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

According to various embodiments, a law enforcement robot is deployed from the police car for in initial interaction with a civilian. This initial interaction can be to identify the civilian during a traffic stop, for example. The initial interaction can include the deployment of the robot so as to initially record and interact with the civilian without direct physical interaction or proximity between the law enforcement officer and the civilian. The robot can accomplish initial audio and video communication between the officer and the civilian. Thus, the robot enables a virtual initial interaction between the officer and the citizen. Where this virtual initial interaction takes place in a traffic stop, the interaction can be considered a robotically enabled on-site virtual traffic stop made by the law enforcement officer using the deployable law enforcement robotic apparatus.

A police car is a ground vehicle used by police for transportation during patrols and to enable them to respond to incidents. Typical uses of a police car include transporting officers so they can reach the scene of an incident quickly, transporting and temporarily detaining suspects in the back seats, as a location to use their police radio or laptop or to patrol an area, all while providing a visible deterrent to crime. Police cars typically have rooftop flashing lights, a siren, and emblems or markings indicating that the vehicle is a police car. Some police cars may have reinforced bumpers, and alley lights for illuminating darkened allies.

According to certain advantageous embodiments, the robot can support a real-time display of the officer's face and provide real-time audio and video communication between the civilian and the officer. For example, the robot can have a screen that is between 6 and 18 inches in width and between 6 and 18 inches in height so as to display the officer's face and impressions to the civilian during the initial interaction. For example, the size and shape of the robotic display can be similar to that of a conventional tablet, or small flat screen, and may include a touch screen, or even be detachable from the robot so as to be used as an input device or more closely view the officer from within the police or civilian car.

Communication between the officer and the civilian can be accomplished in real-time where the video and audio recordings of the officer and the civilian are transmitted between the robot and an officer terminal. The law enforcement officer terminal can be disposed within the police car and can include a display and audio/video means for direct commination between the officer and the citizen via the robot.

The law enforcement officer terminal can have a control apparatus for controlling the navigation apparatus of the robot. For example, the law enforcement officer terminal can have a joystick, or other virtual or manual directional controls, for transmitting a navigational control signal to direct the land navigation of the robot. Upon deployment, the robot has transport means such as rotatable wheels and a chassis for land-based transportation of the robot to the citizen's vehicle.

Upon approaching the citizen's vehicle, the robot captures video via a camera supported by the robot recording and transmitting the video data showing the citizen so as to allow the police officer to assess the initial situation. Thus, the officer is able to view the citizen, view into the citizen's vehicle, and use the audio and video technology of the robot to interact with the citizen prior to direct physical proximity between the officer and the citizen.

The robot can also include an identification receptacle for obtaining the identification of the citizen, such as the citizen's driver's license. The identification receptacle can be extendable from the robot and the officer can audibly request that the identification be placed in the receptacle by the citizen. Once the identification is obtained by the robot, the robot can recognize an indicia on the identification, transmit an image of the identification, or otherwise authenticate the citizen's identification with a database. The robot can also transmit an image of the identification to the officer for authentication via a criminal database. The robot may also retain the identification and return to the police car so as to provide the actual identification to the law enforcement officer. Advantageously, the law enforcement officer can compare the identification with the real-time imagery of the citizen captured by the robot so as to ascertain the authenticity of the identification supplied prior to initial direct interaction with the citizen. The imagery and audio of the interaction can be recorded, replayed, compared side-by-side or via software, and reviewed by the officer so as to make certain that the identification of the citizen is accurate and authentic.

The robot can also be designed to place the citizen at ease while the officer checks the identification supplied. For example, the robot can make clear that it is unarmed and only a surveillance robot. The lack of a weapon on the robot can be made clear to the citizen using audible ques, and the robot can include a minimal of excess devices so as to visually show that this is merely a communications robot and is incapable of harm to the citizen. Thus, having a relatively large display screen showing the actual face of the officer will also allow for the citizen to interact personally with the officer while allowing the initial physical human isolation using this robot.

The position of the robot can also be placed so as to offer a better viewpoint for the officer to inspect the vehicle from within the safety of the officer's police car. An extendable, sometimes multiple or additional, camera mount can be used that can be directed independent, or in addition to, the position of the visual display. For example, one or more cameras mounted to the base or vertical support can offer optional or additional positional viewpoints by the robot.

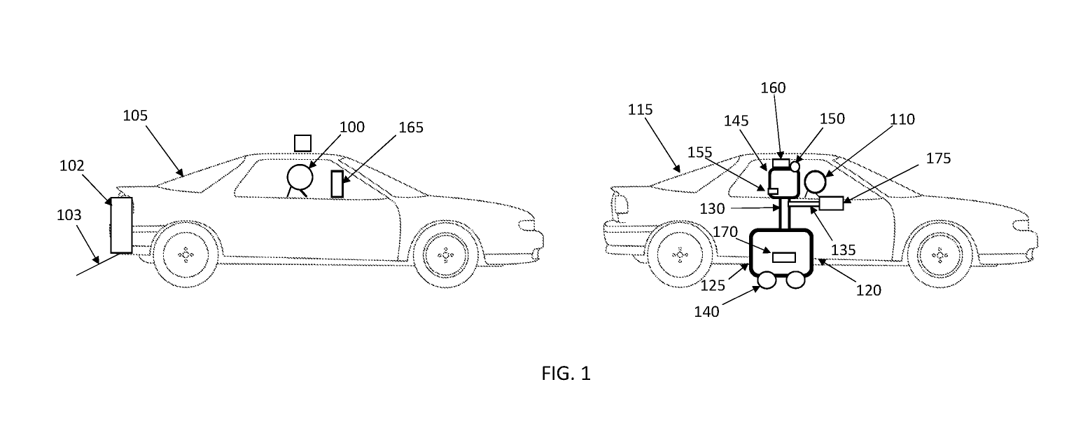

Referring to FIG. 1, an initial law enforcement stop between a law enforcement officer 100 in a law enforcement vehicle 105 and a citizen 110 in the citizen's vehicle 115 is shown. A mobile law enforcement robotic apparatus 120 provides an on-site interaction interface between the law enforcement officer 100 and the citizen 110 during the initial on-site law enforcement interaction. The mobile law enforcement robotic apparatus 120 provides the initial interpersonal interaction between the officer 100 and the citizen 110.

For example, upon coming to a traffic stop as shown in FIG. 1, the law enforcement robotic apparatus 120 is deployed from the law enforcement vehicle 105 and approaches the citizen 110 vehicle 115. This initial interaction may occur on the side of a roadway where the police officer 100 would traditionally leave the law enforcement vehicle 105 to make this initial interaction with the citizen 110 in this scenario. It should be understood that other scenarios are envisioned where the citizen 110 may also be on-foot or there may be a crowd and the use of the law enforcement robotic apparatus 120 may be deployed from the law enforcement vehicle 105. Nevertheless, in the example of the traffic stop shown in FIG. 1 the law enforcement robotic apparatus 120 is deployed from the law enforcement vehicle 105 and facilitates the initial interpersonal interaction between the citizen 110 and the officer 100. The law enforcement robotic apparatus 120 can be deployed from the vehicle using a connector 102 or ramp 103 of the police car 105

The mobile law enforcement robotic apparatus 120 includes a support structure. In this example the support structure includes a base 125, an extendable vertical support 130 and an extendable lateral support 135. The extendable vertical support 130 is vertically extendable relative to the base 125 and the extendable lateral support 135 is extendable laterally from the vertical support 130 according to this example.

The law enforcement robotic apparatus 120 can include transport means 140. The transport means 140 can be land transport means, although an airborne transport means such as a drone can also be used. The transport means 140 can include wheels as shown and are rotationally and drivably coupled to the base 125 of the support structure. The wheels of the transport means 140 may be battery driven by a motor (not shown). The transport means 140 are configured to transport the mobile law enforcement robotic apparatus 120 to different land positions including from the law enforcement vehicle 105 to the citizen vehicle 115.

The mobile law enforcement apparatus 120 includes a visual display 145 supported by the vertical support 130. The visual display 145 is sized to display law enforcement officer imagery including the face of the law enforcement officer 100 during the initial on-site law enforcement interaction.

A camera 150 is supported by the support structure, in this instance is incorporated into, or adjacent to, the display 145. The camera 150 captures real-time imagery of the citizen 110 during the initial on-site law enforcement interaction. The camera 150 can also be disposed on a separate extendable support so as to reposition the camera 150 to capture different locations of the citizen 110 or to stream video of capturing the interior of the citizen's vehicle 115 from outside of the citizen's vehicle 115 as previously discussed.

A microphone 155 is supported by the display 145 and vertical support structure 130. The microphone 155 is configured for receiving audio communication from the citizen 110 during the initial on-site law enforcement interaction. A speaker 160 is supported by the display 145. The speaker 160 is configured for transmitting officer audio communication to the citizen 110 during the initial on-site law enforcement interaction. The speaker 160, camera 150, microphone 155 can be disposed together in an audio-visual communications module, or may be disposed along with the display 145 or other part of the law enforcement robotic apparatus 120.

A communications module 170 of the mobile law enforcement robotic apparatus 120 includes a wireless transceiver, the wireless transceiver for transmitting and receiving wireless data to and from the mobile robotic apparatus 120 during the initial on-site law enforcement interaction.

The communications module 170 can include a video communications module configured to receive the officer imagery from the wireless transceiver during the initial on-site law enforcement interaction. The communications module can further display the officer imagery on the visual display 145 depicting the officer 100 during the initial on-site law enforcement interaction. The communications module 170 can receive the citizen's 110 imagery from the camera 150 depicting the citizen 110 during the initial on-site law enforcement interaction. The communications module 170 includes a wireless transceiver module that transmits the citizen imagery from the camera 150 to the officer terminal 165.

The communications module 170 includes an audio communications module configured to receive officer audio communication data from the wireless transceiver during the initial on-site law enforcement interaction. The communications module 170 transmits the officer audio communication data to the speaker 160 during the initial on-site law enforcement interaction. The communications module 170 receives citizen audio communication from the microphone 155 during the initial on-site law enforcement interaction. And, the communications module 170 transmits citizen audio communication via its wireless transceiver during the initial on-site law enforcement interaction to the officer terminal 165.

The mobile robot 120 further includes an deployable holder 175 that can include an identification receptacle and/or chemical sensors such as olfactory and chemical sniffers. The chemical sensors can include alcohol, drug, explosive, and other chemical sensors. The deployable arm, which can include an identification receptacle and/or chemical sensor 175 is disposed on the horizontal extendable support 135 for extension away from the vertical support structure 130 of the robotic apparatus 120.

The visual display 145 can be rotatable about the vertical support structure 130 so as to re-orient the display 145 toward the citizen 110. The visual display 145 can be repositionable in any direction about the vertical support 130 to direct the visual display toward the citizen 110 or to capture a view of the vehicle 115 using the camera 150. The visual display 160 can be repositionable so as to protect the display 145 during transport by a law enforcement vehicle 105. For example, the display 145 can be retractable into the base 125 of the robot 120 and extendable therefrom when the robot 120 has approached the citizen 110 vehicle 115.

FIG. 1 also illustrates the mobile law enforcement communications system for providing initial on-site interaction between a law enforcement officer 100 and the citizen 110. This system can include the mobile law enforcement robot 120 and the officer terminal 165. This system can include the mobile law enforcement robot 120, officer terminal and law enforcement vehicle 105.

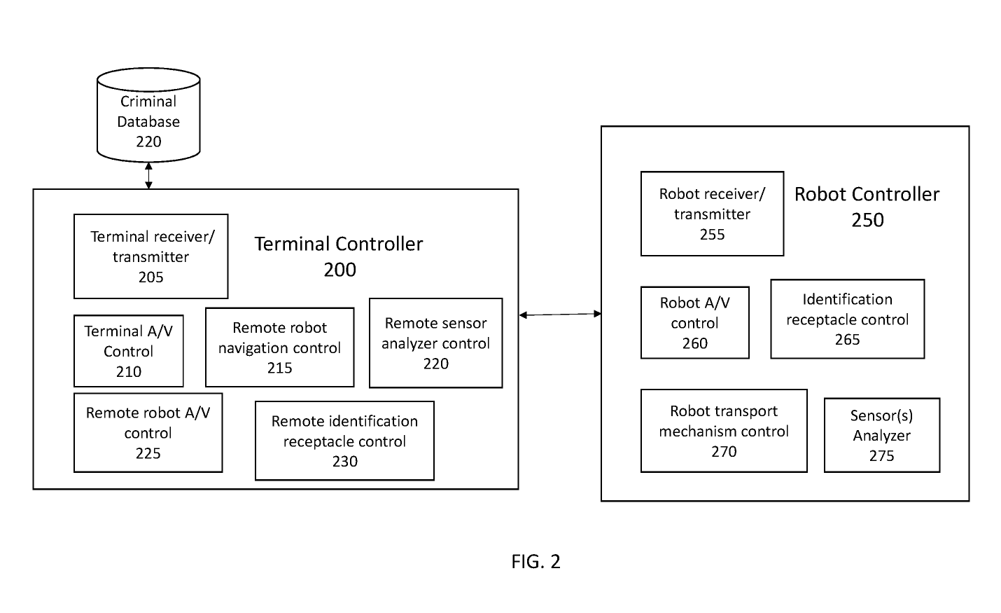

Referring to FIG. 2, communication modules of the law enforcement systems and apparatus are illustrated. A robot controller 250 includes a wireless communications module 255 for transmitting and receiving data. A robot audio and video communications control module 260 includes audio and visual sensors for capturing audio and video data of a citizen. An identification receptacle control module 265 controls an identification receptacle and may also control an image capture or identification authentication sensor so as to scan and otherwise provide authenticating information to the law enforcement officer. A sensor and analyzer control module 275 can control and monitor a chemical sensor for sensing and monitoring the presence of certain chemicals. In one embodiment, the chemical sensor can include an olfactory and chemical sniffer, breath analyzer, or other chemical presence. A robot transport mechanism control module 270 controls the transport mechanism of the robot and can receive control input from the officer so as to navigate and move the robot over land to and from the citizen's vehicle.

A law enforcement officer terminal controller 200 includes a transceiver 205 in wireless communication with the wireless transceiver 255 of the law enforcement robot controller 250. The terminal controller 200 includes an audio and video control module 210 for displaying the audio and video data received from the robot controller 250. The terminal controller 210 is in communication with a criminal database 220 that can be in direct communication with the terminal controller 200 or available over a network.

The terminal controller 200 further includes a remote robot navigation control module 215 for remotely controlling the transport mechanism controller 270 to navigate the robot when deployed from the law enforcement vehicle. The terminal controller 200 also includes a remote identification receptacle controller 230 to transmit control instructions to the robot identification receptacle controller 265.

In addition to the control of the audio and video display on a visual display of the configured to display real-time imagery of the scene received from the robotic apparatus during the initial interaction, the terminal controller 200 further includes a remote robot A/V controller 225 that controls the audio and video display on the robot. For example, the officer may deem it necessary to mute or discontinue transmission of audio or video information to the citizen for privacy, security, or for other purposes. The officer may also choose to have pre-recorded messages or imagery displayed to the citizen for various reason such as to put the citizen at ease while the officer checks the identification or issues a citation.

The terminal controller 200 further includes a remote robot sensor and analyzer control and monitoring module 220 that controls and receives information from the sensor analyzer module 275 of the robot. Such information and control can be deployment or data received from the chemical sensor and analyzer module 275 of the robot controller 250.

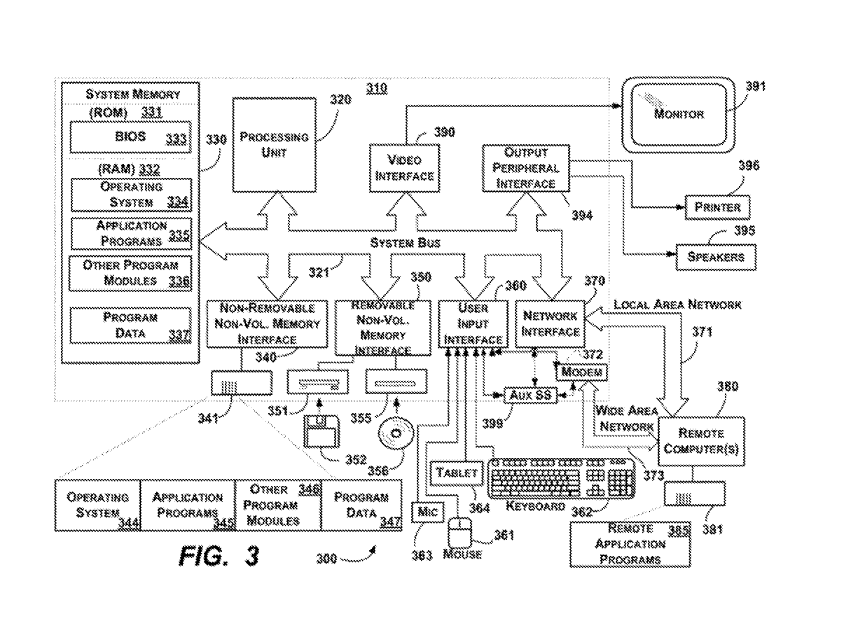

With reference to FIG. 3, an example of a computing system 310 that includes various examples of individual devices that can be included in the officer terminal and/or mobile law enforcement robotic apparatus are illustrated. The individual devices of the computing system 310 can include officer terminal components. That is, the officer terminal can be a laptop or other computing device in wireless communication with the mobile robotic apparatus. The officer terminal computing system 310 itself can include one or more connectors for external connection to peripheral devices and for direct connection to the robot prior to deployment. With only some or various components officer computing system 310 can represent components of an officer terminal smart phone, tablet computing device, laptop, etc.

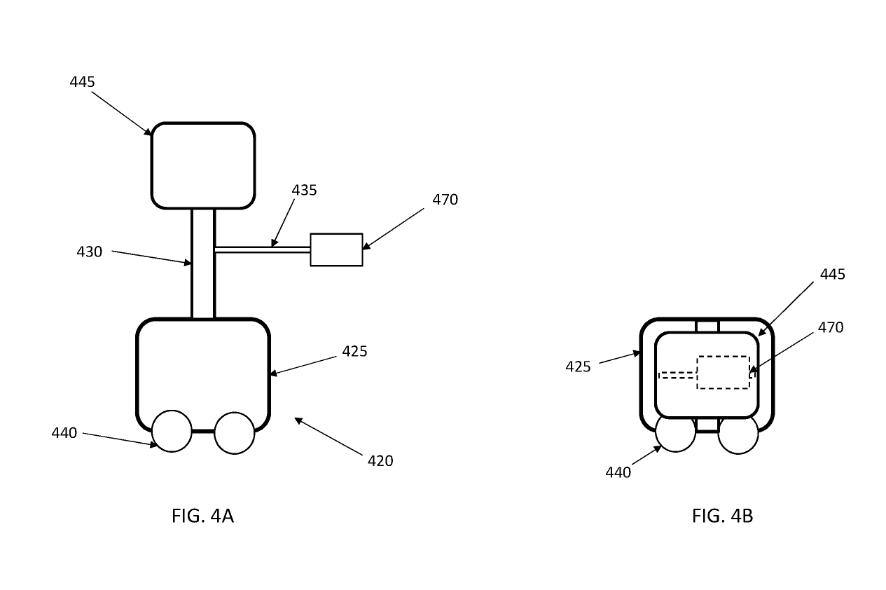

Thus, any device, or combination thereof, illustrated in FIG. 4 can individually include an officer terminal, or robot control device, illustrated therein in combination with any other individual device in combination may also be referred to as an officer terminal device or part of the robot controller.

Components of the officer terminal device 310 may include, but are not limited to, a processing unit 320, a system memory 330, and a system bus 321 that couples various system components including the system memory to the processing unit 320. The system bus 321 may be any of several types of bus structures including a memory bus or memory controller, a peripheral bus, and a local bus using any of a variety of bus architectures.

The officer terminal device 310 can include a variety of computer-readable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices or any other medium which can be used to store the desired information and which can accessed by the computer 310.

The officer terminal device 310 can include a transferable computer-readable media conforming to a connection standard, such as USB or hard drive interface. As previously mentioned, the officer terminal 310 can be wireless communication with the deployable law enforcement robotic apparatus. Wireless communication can be used to perform handshaking to authorize a data connection through the officer terminal 310. In some embodiments, wireless communication may be used to provide a data channel that supplements any data channel established through direct communication prior to deployment of the mobile law enforcement apparatus. In some embodiments, the officer terminal 310 provides only a mechanical connection function, and communication is performed wirelessly for a wireless communication system such as WiFi, and/or Bluetooth.

Bluetooth is a wireless technology standard for exchanging data over short distances (using short-wavelength UHF radio waves in the ISM band from 2.4 to 2.485 GHz) from fixed and mobile devices, and building personal area networks (PANs). Bluetooth is managed by the Bluetooth Special Interest Group (SIG), which has more than 25,000 member companies in the areas of telecommunication, computing, networking, and consumer electronics. The IEEE standardized Bluetooth as IEEE 802.15.1.

A master Bluetooth officer terminal device 310 can communicate with a maximum of seven devices (e.g. devices of the robot) in a piconet (an ad-hoc computer network using Bluetooth technology), though not all devices reach this maximum. The devices of a deployable law enforcement robotic device can switch roles, by agreement, and the slave can become the master (for example, a headset initiating a connection to a phone necessarily begins as master—as initiator of the connection—but may subsequently operate as slave). At any given time, data can be transferred between the master (e.g. officer terminal device 310) and one other device such as the robot controller 250 of FIG. 2 or an individual component thereof. The master chooses which slave device to address; typically, it switches rapidly from one device to another in a round-robin fashion. Since it is the master that chooses which slave to address, whereas a slave is (in theory) supposed to listen in each receive slot, being a master is a lighter burden than being a slave. Bluetooth and Wi-Fi (the brand name for products using IEEE 802.11 standards) have some similar applications.

Communication media transmitted between the officer terminal 310 and the wireless communications controller of the robot (e.g. 120 in FIG. 1) typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal.

The system memory 330 includes computer storage media in the form of volatile and/or nonvolatile memory such as read only memory (ROM) 331 and random access memory (RAM) 332, which can also be configured for communication. A basic input/output system 333 (BIOS), containing the basic routines that help to transfer information between elements within computer 310, such as during start-up, is typically stored in ROM 331. RAM 332 typically contains data and/or program modules that are immediately accessible to and/or presently being operated on by processing unit 320. By way of example, and not limitation, FIG. 3 illustrates operating system 334, application programs 335, other program modules 336 and program data 337.

Certain programs and applications may also be configured for communication between the officer using the officer terminal 310 and the citizen using the audio and video input and output devices of the robot. For example, to the extent that an algorithm or software performs steps and/or acts particular to the officer terminal 310, such algorithms and software can be termed officer terminal protocol or officer terminal processes. As such, to the extent that the form or processing of data is due to the robot communication, such software and processes are further considered under the disclosure herein as robot communication protocols and processes. In the instance that certain functional data structures or data structures are achieved and/or obtained according to such officer terminal and robotic processes, connections, and/or protocols such data structures are further included herein.

The officer terminal computer 310 may also include other removable/non-removable, volatile/nonvolatile computer storage media. By way of example only, FIG. 3 illustrates a hard disk drive 341 that reads from or writes to non-removable, nonvolatile magnetic media, a magnetic disk drive 351 that reads from or writes to a removable, nonvolatile magnetic disk 352, and an optical disk drive 355 that reads from or writes to a removable, nonvolatile optical disk 356 such as a CD ROM or other optical media.

Such examples of officer terminal devices can be included within the robot so as to program, or update, the software and configurations of the robot controller. Moreover, such software, reconfigurations, and updates as well as data structures can be downloaded from the officer terminal 310 to the robot using one or more wired or wireless connections thereto which can be properly viewed as memory when configured to be made accessible to the robot controller.

The hard disk drive 341 is typically connected to the system bus 321 through a non-removable memory interface such as interface 340, and magnetic disk drive 351 and optical disk drive 355 are typically connected to the system bus 321 by a removable memory interface, such as interface 350, which are all examples of devices that can be directed or indirectly coupled to one or more officer terminal connectors.

The drives and their associated computer storage media, described above and illustrated in FIG. 3 (among other figures and in other combinations and rearrangements), provide storage of computer-readable instructions, data structures, program modules and other data for the officer terminal computer 310. In FIG. 3, for example, hard disk drive 341 is illustrated as storing operating system 344, application programs 345, other program modules 346 and program data 347. Note that these components can either be the same as or different from operating system 334, application programs 335, other program modules 336, and program data 337. These functions of the terminal computer 310 and/or robot controller (e.g. see 250 in FIG. 2) can be remotely located as needed and accessible via a networked cellular or cloud-based configuration.

Operating system 344, application programs 345, other program modules 346, and program data 347 are given different numbers herein to illustrate that, at a minimum, they are different copies. The officer may enter commands and information into the terminal computer 310 through input devices such as a tablet, or electronic digitizer, 364, a microphone 363, a keyboard 362 and pointing device 361, commonly referred to as mouse, trackball or touch pad that can all be part of an input and/or audio and visual device. Other input devices not shown in FIG. 3 may include a joystick, game pad, scanner, or the like which can be coupled to the computer and/or various devices depicted via one or more officer terminal connectors or remote officer terminal communications. These and other input devices are can be connected to the processing unit 320 through a user input interface 360 that is coupled to the system bus (e.g. via officer terminal connection(s)), but may be connected by other interface and bus structures, such as a parallel port, game port or a universal serial bus (USB) via an officer terminal connection(s).

A display device 391 is also connected to the system bus 321 via an interface, such as a video interface 390. The display 391 may also be integrated with a touch-screen panel or the like. Note that the display and/or touch screen panel 391 can be physically coupled to a housing in which the computing device 310 is incorporated, such as in a tablet-type personal computer (i.e. another example of the many officer terminal devices disclosed herein). In addition, computers such as the computing device 310 may also include other peripheral output officer terminal devices such as speakers 395 and traffic ticket printer 396, which may be connected through an output peripheral officer terminal interface 394 or the like. The robot can also include a ticket printer 396 or other components for issuing a citation.

The officer terminal computer 310 may operate in a networked environment using logical connections to one or more remote computers, such as a remote officer terminal computer 380. The remote officer terminal computer 380 may be a personal computer, an officer terminal server, a router, an officer terminal peer device, or other officer terminal network node, and includes many or all of the elements described above relative to the officer terminal computer 310. The logical connections depicted in FIG. 3 include one or more local area networks (LAN) 371 and one or more wide area networks (WAN) 373 that can use a common law enforcement vehicle borne network, but may also include other networks. Such networking environments are commonplace in law offices, enterprise-wide computer networks, intranets and the Internet.

When used in a LAN networking environment, for example in communication with another law enforcement computer, the officer terminal computer 310 is connected to the LAN 371 through a network interface or adapter 370. When used in a WAN networking environment, the officer terminal computer 310 typically includes a modem 372 or other means for establishing communications over the WAN 373, such as the Internet. The modem 372, which may be internal or external, may be connected to the system bus 321 via the user input interface 360 or other appropriate mechanism. A wireless networking component 374 such as comprising an interface and antenna may be coupled through a suitable device such as an access point or peer computer to a WAN or LAN. In a networked environment, program modules depicted relative to the computer 310, or portions thereof, may be stored in the remote memory storage device. By way of example, and not limitation, FIG. 3 illustrates remote application of officer terminal programs 385 as residing on memory device 381. It may be appreciated that the network connections shown are exemplary and other means of establishing a communications link between the computers may be used.

An auxiliary officer terminal subsystem 399 (e.g., for auxiliary display of content) may be connected via the user interface 360 to allow data such as program content, system status and event notifications to be provided to the user, even if the main portions of the computer system are in a low power state. The auxiliary subsystem 399 may be connected to the modem 372 and/or network interface 370 to allow communication between these systems while the main processing unit 320 is in a low power state.

Various other officer terminal devices are discussed herein that are coupled for connection or communication via with the officer terminal 310 and/or the robot controller 250 and may include one or more of the previously mentioned officer terminal devices, interfaces, connectors, peripherals and/or accessories.

Various officer terminal and robotic devices can include means for performing the various functions. Such means when thereby termed includes the structures and combinations therefor as well as comparable structures such as any of those disclosed in FIG. 3. Certain devices may be described as including structures for streaming data, displaying data, controlling other devices and/or cooperating with various other devices. Combinations of structure means may not be necessary, however, to achieve such functions.

As previously discussed the police vehicle can include a connector or ramp for deployment of the mobile robotic apparatus therefrom. The deployment of the robotic apparatus can be actuated from within the vehicle by the police officer and controlled remotely thereby as the navigation of the robot is controlled from the officer terminal.

Referring to FIGS. 4A and 4B, a deployable robotic apparatus 420 is shown. In this embodiment, the robotic apparatus 420 is substantially collapsible within a base 425. In this embodiment, the robot 420 includes a transport apparatus 440 in the form of wheels as well as a vertically extendable support 430 for an audio and visual device 445 such as a display, camera, microphone, and speakers. The robotic apparatus 420 also includes an extendable arm 435 and identification receptacle and/or chemical sensor and analyzer 470. The chemical sensor can also be disposed within the robotic apparatus 420 as opposed or in addition to disposed at the receptacle or other deployable platform.

However, as shown in FIG. 4B, the robotic apparatus 420 is collapsible so as to fit one or more of the extendable structural components and articulated devices thereby within the housing 425 of the robotic apparatus 420. As such, the robotic apparatus 420 can be more easily transported by an officer from location-to-location.

In such embodiments, the robotic apparatus 420 can be substantially portable and relatively light weight as opposed to otherwise bulky robotic devices. For example, the robotic apparatus of FIGS. 4A and 4B can be similar in size and weight to carry-on luggage or a briefcase. While the embodiment of FIGS. 4A and 4B illustrate a collapsible embodiment, an assembleable embodiment is also considered within such teachings where the extendable and retractable portion(s) can be readily supplied and attached by the officer prior to deployment.

The robotic apparatus 420 (or 120) can be substantially lightweight as weighting between 10 and 50 pounds, such as between 20 and 30 pounds. The size of the collapsed robot shown in FIG. 4B can be less than 2.5 feet high and 2.5 feet wide, such as between 1 and 2 feet high and 1 and 2 feet wide or even about 1.5 feet wide by about 1.5 feet high.

One skilled in the art will appreciate that, for this and other processes and methods disclosed herein, the functions performed in the processes and methods may be implemented in differing order. Moreover, the structures of apparatus may be reorganized or variated used to accomplish a given feature or function. Furthermore, the outlined steps and operations are only provided as examples, and some of the steps and operations may be optional, combined into fewer steps and operations, or expanded into additional steps and operations without detracting from the essence of the disclosed embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims. All references recited herein are incorporated herein by specific reference in their entirety.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A mobile law enforcement communications system for providing initial on-site interaction between a law enforcement officer and a citizen, comprising:
a mobile law enforcement robot including:
a robotic transportation apparatus for transporting the robot proximate to the citizen;
a robotic wireless communications module for transmitting and receiving data with a law enforcement officer terminal; and
a robotic audio and visual communication device configured to display real-time video data and communicate real-time audio information from the officer to the citizen during the initial interaction;
the law enforcement officer terminal in wireless communication with the mobile law enforcement robot, including:
an officer terminal wireless communications module for transmitting and receiving data with the mobile law enforcement robot; and
an officer terminal audio and visual communication device configured to display real-time video data and communicate real-time audio information from the citizen to the officer during the initial interaction.

2. The mobile law enforcement communications system according to claim 1, the robotic audio and visual communications device including a display device sized and configured to display a real-time depiction of the face of the officer to the citizen during the initial interaction.

3. The mobile law enforcement communications system according to claim 1, the mobile law enforcement robot further including an identification receptacle for placement of the citizen's identification therein.

4. The mobile law enforcement communications system according to claim 1, the robotic audio and visual communication device including a video display at least 5 inches in width and at least 7 inches in height.

5. The mobile law enforcement communications system according to claim 4, the robotic audio and visual communications device including a robotic microphone and a robotic camera configured to transmit the real-time video data and audio information from the citizen to the robotic wireless communications module for transmitting and receiving data with the law enforcement officer terminal.

6. The mobile law enforcement communications system according to claim 5, the law enforcement officer terminal including an officer terminal microphone and an officer terminal camera configured to transmit the real-time video data and audio information from the officer to the officer terminal wireless communication module for transmitting and receiving data with the mobile law enforcement robot.

7. The mobile law enforcement communications system according to claim 1, the robotic transportation apparatus including drivable wheels coupled to a support structure of the mobile law enforcement robot.

8. The mobile law enforcement communications system according to claim 7, the law enforcement officer terminal further including a robot navigation control module including a navigation control input device for remotely controlling the robotic transportation apparatus.

9. The mobile law enforcement communications system according to claim 1, the law enforcement officer terminal further including remote identification control module including an input device for remotely articulating the position of the robotic identification receptacle.

10. The mobile law enforcement communications system according to claim 1, the law enforcement officer terminal further including a remote robot audio and video control module for remotely controlling the output of audio and visual data to the citizen.

11. The mobile law enforcement communications system according to claim 1, the law enforcement officer terminal further including a remote video control module for controlling a position of a robot camera supported by the mobile law enforcement robot.

12. The mobile law enforcement communications system according to claim 1, the law enforcement officer terminal further including a remote video display control module for controlling a position of a video display depicting the face of the officer to the citizen during the initial on-site interaction.

13. A mobile law enforcement robotic apparatus providing an on-site interaction interface between a law enforcement officer and a citizen during an initial on-site law enforcement interaction, the robotic apparatus comprising:
support structure;
transport means coupled to the support structure and configured to transport the robotic apparatus to different positions;
a visual display supported by the support structure, the visual display sized to display law enforcement officer imagery including the face of the law enforcement officer during the initial on-site law enforcement interaction;
a camera supported by the support structure, the camera capturing real-time imagery of the citizen during the initial on-site law enforcement interaction;
a microphone supported by the support structure, the microphone for receiving audio communication from the citizen during the initial on-site law enforcement interaction;
a speaker supported by the support structure, the speaker for transmitting officer audio communication to the citizen during the initial on-site law enforcement interaction;
a wireless transceiver supported by the support structure, the wireless transceiver for transmitting and receiving wireless data to and from the mobile robotic apparatus during the initial on-site law enforcement interaction;
an electronic communications control module supported by the support structure, the electronic communications control module including:
a video communications module configured to:
receive the officer imagery from the wireless transceiver during the initial on-site law enforcement interaction; and
display the officer imagery on the visual display depicting the officer during the initial on-site law enforcement interaction;
receive the citizen imagery from the camera depicting the citizen during the initial on-site law enforcement interaction; and
transmit the citizen imagery to the wireless transceiver module during the initial on-site law enforcement interaction;
an audio communications module configured to:
receive officer audio communication data from the wireless transceiver during the initial on-site law enforcement interaction;
transmit the officer audio communication data to the speaker during the initial on-site law enforcement interaction;
receive citizen audio communication from the microphone during the initial on-site law enforcement interaction; and
transmit citizen audio communication to the wireless transceiver during the initial on-site law enforcement interaction.

14. The mobile robot according to claim 13, further comprising a vehicular connector designed to connect the mobile robot to a law enforcement vehicle.

15. The mobile robot according to claim 13, further comprising a citizen identification receptacle.

16. The mobile robot according to claim 15, wherein the identification receptacle is disposed on an extendable support for extension from the support structure of the robotic apparatus.

17. The mobile robot according to claim 13, wherein the visual display is repositionable about the support structure to direct the visual display toward the citizen.

18. The mobile robot according to claim 13, wherein the visual display is repositionable so as to protect the display during transport by a law enforcement vehicle.

19. An officer terminal providing an on-site interaction interface between a law enforcement officer and a citizen during an initial on-site law enforcement interaction, the officer terminal comprising:
a camera for capturing the face of the law enforcement officer during the initial on-site law enforcement interaction;
a speaker for recoding real-time spoken instructions by the law enforcement officer during the initial on-site law enforcement interaction;
an audio and video communications module for remotely controlling real-time audio and visual communication with the citizen using a mobile law enforcement robot; and
a robot controller module for remotely controlling electro-mechanical activity of the mobile law enforcement robot.

20. The officer terminal according to claim 19, the robot controller module remotely controlling a robotic transportation apparatus of the mobile law enforcement robot to provide remote land navigation while deploying the mobile law enforcement robot from a police vehicle to the citizen's vehicle.
